(19) United States
(12) Patent Application Publication
(10) Pub. No.: US 2024/0120623 A1
(43) Pub. Date: Apr. 11, 2024

(54) RECHARGEABLE BATTERY

(71) Applicant: SAMSUNG SDI CO., LTD., Yongin-si (KR)

(72) Inventors: Sunggwi KO, Yongin-si (KR); Jeongchull AHN, Yongin-si (KR); Gungue PARK, Yongin-si (KR)

(21) Appl. No.: 18/470,883

(22) Filed: Sep. 20, 2023

(30) Foreign Application Priority Data
Oct. 6, 2022 (KR) 10-2022-0128114

(51) Int. Cl. H01M 50/533; H01M 10/0587; H01M 50/179; H01M 50/184; H01M 50/342

(52) U.S. Cl. CPC H01M 50/533; H01M 10/0587; H01M 50/179; H01M 50/184; H01M 50/3425

(57) ABSTRACT

A rechargeable battery includes an electrode assembly having a first electrode, a separator, and a second electrode; a case accommodating the electrode assembly; an electrode terminal; a first current collecting plate connecting the first electrode to the electrode terminal; a vent plate; a second current collecting plate connecting the second electrode to a beading portion of the case at an inner side of the vent plate; and a gasket between the second collecting plate and the vent plate and between the second collecting plate. The second current collecting plate includes a base portion on the second electrode, a bottom welding portion extending in a radial direction from the base portion and welded to the second electrode, and a wing welding portion spaced apart from the bottom welding portion and connected to the base portion by an elastic portion and welded to the beading portion.

### CROSS-REFERENCE TO RELATED APPLICATION

This application claims priority to and the benefit of Korean Patent Application No. 10-2022-0128114 filed in the Korean Intellectual Property Office on Oct. 6, 2022, the entire contents of which are incorporated herein by reference.

### BACKGROUND

### 1. Field

The present disclosure relates to a rechargeable battery, and more particularly, to a rechargeable battery that may connect a current collecting plate to a case at one side of a gasket.

### 2. Description of the Related Art

Demand for rechargeable batteries as an energy source is increasing according to demand for mobile devices and technological development. For example, a cylindrical rechargeable battery includes an electrode assembly for charging and discharging, a case accommodating the electrode assembly, and a cap assembly electrically connected to the electrode assembly to seal an opening side of the case.

For example, the electrode assembly is formed by arranging a positive electrode and a negative electrode on both surfaces of a separator, and winding the positive electrode, the separator, and the negative electrode in a jelly roll form. In the electrode assembly, one electrode is connected to the cap assembly through the current collecting plate, and the other electrode is connected to the case through a lead tab.

The cap assembly includes a current interrupt device (CID), and the opening of the case is closed and sealed by a beading portion and a crimping portion around a gasket between the current interrupt device and the case. As the gasket is compressed by the beading portion and the crimping portion, an inner end of the gasket may interfere with the current collecting plate, and thus the sealing force of the gasket with respect to the opening may be deteriorated.

In order to maintain the sealing force of the gasket, the current collecting plate may be connected to the beading portion of the case at one side of the gasket. However, an interference phenomenon in which one portion of the current collecting plate is connected to an electrode uncoated portion and the other portion of the current collecting plate presses the electrode uncoated portion may occur.

### SUMMARY

The present disclosure has been made in an effort to provide a rechargeable battery that may prevent interference between a current collecting plate and an electrode uncoated portion while also sealing a case opening with a gasket.

An embodiment provides a rechargeable battery including: an electrode assembly including a first electrode, a separator, and a second electrode in a jelly roll configuration; a case accommodating the electrode assembly; an electrode terminal installed in an insulating state at a first opening on one side of the case; a first current collecting plate connecting the first electrode to the electrode terminal; a vent plate sealing a second opening on an other side of the case; a second current collecting plate connecting the second electrode to a beading portion of the case at an inner side of the vent plate; and a gasket between the second collecting plate and the vent plate and between the second collecting plate and the case to form a seal between a crimping portion and the beading portion. The second current collecting plate includes a base portion on an uncoated portion of the second electrode, a bottom welding portion extending in a radial direction from the base portion and welded to the uncoated portion of the second electrode, and a wing welding portion spaced apart from the bottom welding portion and connected to the base portion by an elastic portion and welded to the beading portion.

Two or more of the bottom welding portion and two or more of the wing welding portion may be alternately arranged in a circumferential direction on the base portion.

A through-hole may be formed in a center of the base portion, and the bottom welding portion and the elastic portion may be connected by a concave groove at the base portion.

The bottom welding portion may be coupled to the second electrode by a first welding line along a radial direction of the second current collecting plate, and the wing welding portion may be coupled to the beading portion of the case by a second welding line along a circumferential direction of the second current collecting plate.

The wing welding portion may extend in a circumferential direction longer than a width of the elastic portion.

The elastic portion may include a first elastic bending portion that is connected to the base portion and that is bent upwardly and bent outwardly based in a radial direction, and a second elastic bending portion connected to the first elastic bending portion and the wing welding portion and that is bent upwardly and bent outwardly at an include in a radial direction.

The gasket may include an escape groove accommodating the wing welding portion.

The beading portion may include a flat portion on an upper side of an inwardly convex curved portion, and the wing welding portion may be welded to the flat portion.

The escape groove may include a right angle at a side of the wing welding portion, and the escape groove may include an obtuse angle corresponding to the second elastic bending portion at an inner side in the radial direction.

A notch may be formed on an inner surface of the vent plate.

As described above, according to the embodiment of the present disclosure, since a gasket is sealed by a crimping portion interposed between a second current collecting plate and a case and connected to a beading portion, it is possible to secure sealing force of a case opening by the gasket and to prevent interference between the second current collecting plate and an electrode uncoated portion.

### BRIEF DESCRIPTION OF THE DRAWINGS

FIG. 1 illustrates a longitudinal cross-sectional view of a rechargeable battery according to an embodiment of the present disclosure.

FIG. 2 illustrates a detail cross-sectional view of the rechargeable battery in a state before a vent plate is coupled by inserting a gasket into a second opening of a case of FIG. 1.

FIG. 3 illustrates a perspective view of a second current collecting plate of the rechargeable battery of FIG. 1.

FIG. 4 illustrates a cross-sectional view of a gasket of the rechargeable battery of FIG. 2.

FIG. 5 illustrates a cross-sectional view of the rechargeable battery in a state in which a vent plate is coupled to a second opening of a case with a gasket in the state of FIG. 2.

### DETAILED DESCRIPTION

The present invention will be described more fully hereinafter with reference to the accompanying drawings, in which embodiments of the invention are shown. As those skilled in the art would realize, the described embodiments may be modified in various different ways, all without departing from the spirit or scope of the present disclosure. The drawings and description are to be regarded as illustrative in nature and not restrictive. Like reference numerals designate like elements throughout the specification.

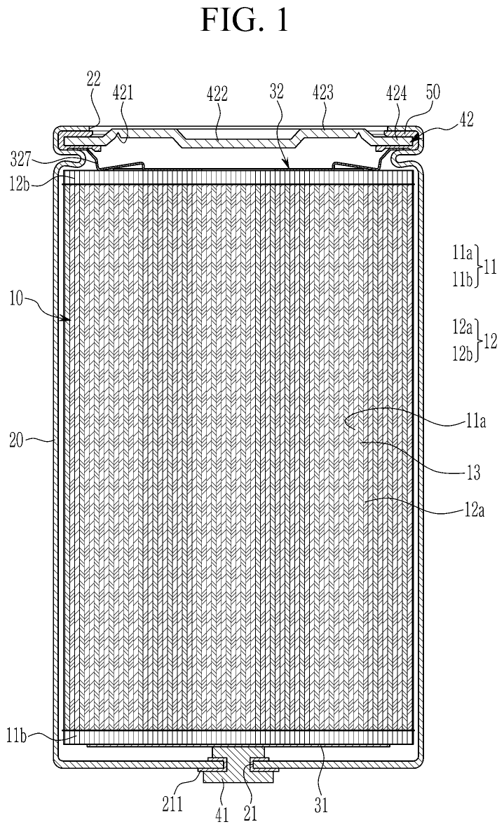

FIG. 1 illustrates a longitudinal cross-sectional view of a rechargeable battery according to an embodiment of the present disclosure. Referring to FIG. 1, the rechargeable battery according to the embodiment includes an electrode assembly 10 for charging and discharging, a case 20 accommodating the electrode assembly 10, a first current collecting plate 31, a second current collecting plate 32, an electrode terminal 41 connected to the electrode assembly 10, a vent plate 42, and a gasket 50.

The electrode assembly 10 is formed in a jelly roll state by winding a first electrode 11, a separator 13, and a second electrode 12. The first electrode 11 and the second electrode 12 include coating portions 11a and 12a, respectively, in areas in which active materials are applied on both surfaces of substrates formed of thin metal plates, and non-coated portions 11b and 12b, respectively, in areas in which the active materials are not applied and the substrates are exposed.

As an example, the first electrode 11 may form a positive electrode by coating a positive electrode active material on an aluminum (AI) substrate, and the second electrode 12 may form a negative electrode by coating a negative electrode active material on a copper (Cu) substrate. The uncoated portions 11b and 12b of the first and second electrodes 11 and 12, respectively, are provided at both ends of the electrode assembly 10 in a direction of a winding axis (both upper and lower ends in FIG. 1), but are provided together with the electrode terminal 41 and the case 20 having different polarities in the same direction. The vent plate 42 is disposed at the opposite side (or end) of the of the electrode assembly 10 that the electrode terminal 41 is on.

In one or more embodiments, the case 20 is formed in a cylindrical shape to accommodate the electrode assembly 10, and the electrode terminal 41 and the bent plate 42 are provided at both ends of the case 20 in the axial direction (winding axis) corresponding to the uncoated portions 11b and 12b, respectively, of the first and second electrodes 11 and 12. The electrode terminal 41 is connected to the first electrode 11 by the first current collecting plate 31, and the case 20 is connected to the second electrode 12 by the second current collecting plate 32. In this embodiment, the bent plate 42 is electrically separated (insulated) from the second collecting plate 32 and the case 20 and has no polarity.

The electrode terminal 41 connected to the first electrode 11 of the electrode assembly 10 is inserted into the case 20 from the outside and is installed at one side of the case 20. To this end, the case 20 includes a first opening 21 partially opened on one side. The electrode terminal 41 is installed in an electrical insulation state from the case 20 while forming an airtight structure with respect to an electrolyte by inserting a sealing member 211 in the first opening 21.

In this embodiment, the first current collecting plate 31 is electrically connected to the uncoated portion 11b of the first electrode 11 and electrically and mechanically connected to the electrode terminal 41. The first current collecting plate 31 is electrically connected to the electrode terminal 41 in a configuration that reduces resistance by contacting most of the uncoated portion 11b of the first electrode 11.

As an example, the electrode terminal 41 may be connected to the first collecting plate 31 by welding at one end and installed in the first opening 21 of the case 20 in a rivet structure (e.g., the electrode terminal 41 may be riveted in the first opening 21 of the case 20). The electrode terminal 41 may protrude from an outer surface of the case 20 around the first opening 21 to be used as a positive electrode terminal. In this embodiment, the first current collecting plate 31 becomes a positive electrode current collecting plate.

In addition, the case 20 has a second opening 22 that is completely opened to insert the electrode assembly 10 into the other side of the case 20. The vent plate 42 seals the second opening 22 after inserting the electrode assembly 10 into the case 20, and is electrically separated from the case 20.

In this embodiment, the second current collecting plate 32 is electrically connected to the uncoated portion 12b of the second electrode 12 and electrically connected to the case 20. The second current collecting plate 32 is connected to case 20 in a configuration that reduces resistance by contacting most of the uncoated portion 12b of the second electrode 12.

In the illustrated embodiment, the bent plate 42 is electrically separated from the second collecting plate 32, and is installed in the second opening 22 of the case 20 through a crimping process. Due to the connection of the second collecting plate 32, the case 20 may be used as a negative electrode terminal. In this embodiment, the second current collecting plate 32 becomes a negative electrode current collecting plate.

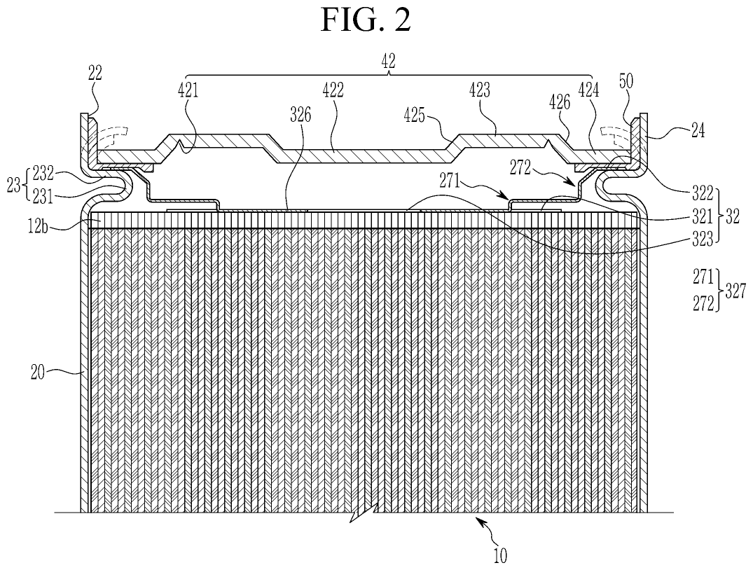

FIG. 2 illustrates a cross-sectional view of a portion of the rechargeable battery in a state before a vent plate is coupled by inserting a gasket into a second opening of a case of FIG. 1. Referring to FIG. 1 and FIG. 2, the second current collecting plate 32 connects the second electrode 12 to the beading portion 23 of the case 20.

Through a beading process, a beading portion 23 is formed adjacent to the second opening 22 of the case 20, and a crimping portion 24 connected to the beading portion 23 is formed through a crimping process. That is, the case 20 includes the beading portion 23 and the crimping portion 24.

The beading portion 23 has a configuration in which the electrode assembly 10 is recessed inward toward a center of the case 20 in a diameter direction of the case 20 at an upper side of the case 20 while the electrode assembly 10 is accommodated in the case 20, thereby preventing the electrode assembly 10 from moving up and down (e.g., the beading portion 23 is configured to retain the electrode assembly 10 in the case 20).

The crimping portion 24 is connected to the beading portion 23 in a configuration that protrudes from the beading portion 23 in the diameter direction. By the crimping process, the beading portion 23 is deflected downward (e.g., the beading portion 23 is angled downward along an inward diameter direction of the case 20).

The gasket 50 is used in the crimping process. After the crimping process, the gasket 50 is between the second collecting plate 32 and the bent plate 42 and between the second current collecting plate 32 and the case 20. The gasket 50 performs a sealing-function because the beading portion 23 and the clamping portion 24 are connected to the gasket 50. In addition, the gasket 50 forms an airtight structure with respect to the electrolyte solution between the second collecting plate 32 and the second opening 22 of the case 20.

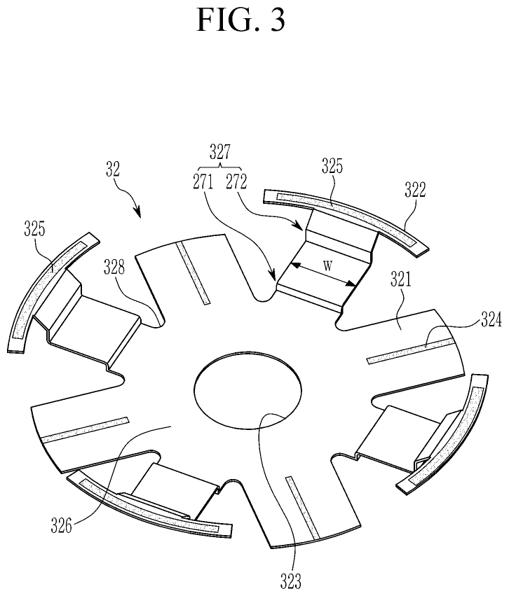

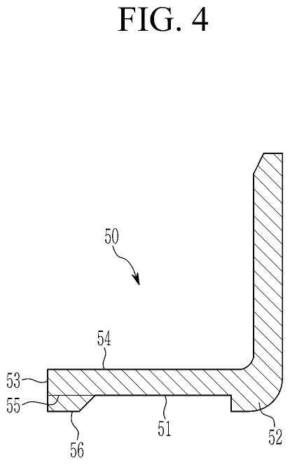

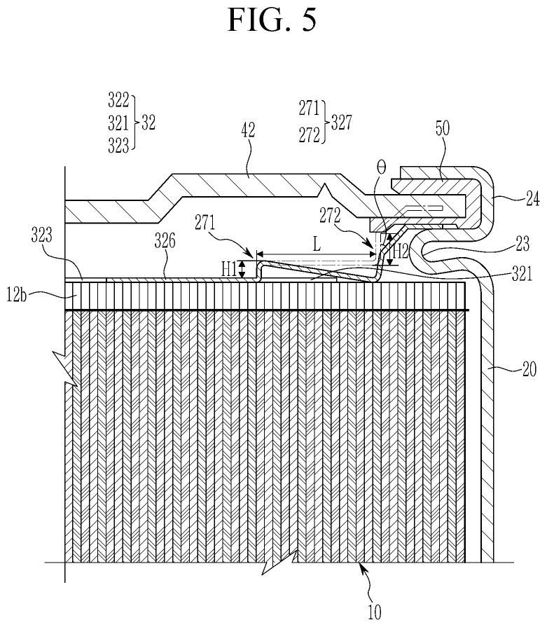

FIG. 3 illustrates a perspective view of the second current collecting plate 32 utilized in the embodiment of the rechargeable battery shown in FIG. 1. FIG. 4 illustrates a cross-sectional view of the gasket 50 utilized in the embodiment shown in FIG. 2. FIG. 5 illustrates a cross-sectional view of a state in which the vent plate 42 is coupled to the second opening of the case 20 with the gasket 50 interposed in the state of FIG. 2.

Referring to FIG. 3 to FIG. 5, the second current collecting plate 32 includes a base portion 326, a bottom welding portion 321, an elastic portion 327, and a welding wing portion 322. During assembly, the base portion 326 is placed on the uncoated portion 12b of the second electrode 12.

The bottom welding portion 321 extends in a radius direction from the base portion 326 (e.g., the bottom welding portion 321 extends radially outward from the base portion 326) to be welded to the uncoated portion 12b of the second electrode 12. The welding wing portion 322 is spaced apart from the bottom welding portion 321, is connected to the base portion 326 by the elastic portion 327, and is welded to the beading portion 23.

The second current collecting plate 32 is formed by cutting and bending an original plate, and has a plurality of bottom welding portions 321 and a plurality of wing welding portions 322. The bottom welding portions 321 and the wing welding portions 322 are alternately arranged in the base portion 326 along a circumferential direction. Accordingly, the bottom welding portion 321 and the wing welding portion 322 may form a balanced structure along the circumferential direction.

During welding, the bottom welding portion 321 forms a first welding line 324 in the diameter direction. The wing welding portion 322 forms a second welding line 325 along the circumferential direction. The wing welding portion 322 extends in the circumferential direction longer than a width W of the elastic portion 327 (e.g., the wing welding portions 322 overhang edges of the elastic portions 327).

Accordingly, the bottom welding portion 321 is evenly connected along the circumferential direction in the area of the uncoated portion 12b, and the wing welding portion 322 is evenly connected along the circumferential direction in the area of the beading portion 23. In the second electrode 12, a uniform current flow (or substantially uniform current flow) is possible along the circumferential direction in the entire area of the beading portion 23 of the case 20.

The elastic portion 327 may be formed by repeatedly bending it in an axial direction (upward) and bending it in an outer radial direction. As an example, the elastic portion 327 includes a first elastic bending portion 271 and a second elastic bending portion 272.

The first elastic bending portion 271 is connected to the base portion 326, bent upwardly, and then bent outwardly based on the radial direction. An upward height H1 (see FIG. 5) of the first elastic bending portion 271 prevents the second elastic bending portion 272 from being separated from the uncoated portion 11b to interfere with the uncoated portion 11b.

The second elastic bending portion 272 is connected to the first elastic bending portion 271, bent upward, and then is outwardly and upwardly bent based on the radial direction and connected to the wing welding portion 322. A bent upward height H2 of the second elastic bending portion 272 and an inclined angle θ thereof at which the second elastic bending portion 272 is bent upward and outward based on the radial direction prevent interference with the beading portion 23.

A length L (see FIG. 5) from a bending start point of the first elastic bending part 271 to the upward bending point of the second elastic bending portion 272 in the radial outer direction imparts elasticity to the elastic portion 327, so that the upwardly bending point of the second elastic bending portion 272 has a force (e.g., an elastic restorative force) to move upward away from the uncoated portion 11b. Accordingly, the length L of the elastic portion 327 further prevents the second elastic bending portion 272 from interfering with the uncoated portion 11b by separating it from the uncoated portion 11b.

In addition, the base portion 326 has a through-hole 323 in a center thereof, and the bottom welding portion 321 and the elastic portion 327 are connected to a concave groove 328 in the base portion 326. The through-hole 323 and the concave groove 328 may absorb and alleviate deformation caused by welding the bottom welding portion 321 to the uncoated portion 12b and vibration and impact that may be transmitted between the wing welding portion 322 and the bottom welding portion 321. The through-hole 323 and the concave groove 328 may have a size within a range capable of absorbing vibration and impact without increasing current resistance between the wing welding portion 322 and the bottom welding portion 321.

The beading portion 23 includes a flat portion 232 (see FIG. 2) formed parallel to a flat surface formed by a cross-section of the uncoated portion 11b at an upper side of an inwardly convex curved portion 231 of the beading portion 23. The wing welding portion 322 of the second current collecting plate 32 is welded to the flat portion 232 of the beading portion 23. Accordingly, the second current collecting plate 32 is stably contacted and welded to the case 20 of the beading portion 23 to further realize a uniform flow of current.

In addition, since the wing welding portion 322 extends further along the circumferential direction than the width W of the elastic portion 327 connected to the base portion 326, the contact area and welding area with the flat portion 232 may be further increased to prevent an increase in resistance in the welding portion.

In this embodiment, the gasket 50 has an escape groove 51 (see FIG. 4) accommodating the wing welding portion 322. The escape groove 51 increases stability of the gasket 50 by reducing deformation of the gasket 50 between the wing welding portion 322 and the vent plate 42 during the crimping process.

The gasket 50 further includes a compression portion 52 that comes into contact with the flat portion 232 at the outer side based on the radial direction of the escape groove 51 to act as a compression airtight seal. Despite the escape groove 51, the compression portion 52 achieves a sufficient airtight seal between the flat portion 232 and the vent plate 42.

In the illustrated embodiment, the escape groove 51 is formed at a right angle at the compression portion 52 side to stably accommodate the end of the wing welding portion 322 to prevent misalignment between the wing welding portion 322 and the gasket 50. In one or more embodiments, the escape groove 51 may be formed at an obtuse angle at the inner side based on the radial direction to induce coupling of the bending structure of the wing welding portion 322, the elastic portion 327, and the second elastic bending portion 272 and to stably accommodate the bending structure of the wing welding portion 322, the elastic portion 327, and the second elastic bending portion 272. The wing welding portion 322, the elastic portion 327, and the second elastic bending portion 272 may be bent to correspond to the obtuse structure of the escape groove 51.

Referring to FIG. 4, the gasket 50 has a through-hole 53 inside the escape groove 51 in the radial direction. The through-hole 53 connects an upper surface 54 and a lower surface 55 of the gasket 50 at right angles to the side thereof. The gasket 50 further includes a convex portion 56 (e.g., a downward protrusion) convexly formed at the inside to further form the through-hole 53 inward in a through-direction. The convex portion 56 prevents the bending structure of the wing welding portion 322, the elastic portion 327, and the second elastic bending portion 272 from being pushed to the vent plate 42.

Since the through-hole 53 of the gasket 50 is formed to correspond to an outer portion 424 of the vent plate 42, the inner side of the gasket 50 compressed and deformed by the crimping process may be prevented from interfering with the second collecting plate 32.

The vent plate 42 forms a notch 421 (see FIG. 2) on the inner surface thereof. During a rechargeable battery event, the notch 421 is cut (e.g., broken) to discharge internal pressure, thereby preventing secondary explosion. The vent plate 42 is formed in a circular plate and includes a central portion 422, a convex portion 423, and the outer portion 424.

The central portion 422 is formed to be concave toward the electrode assembly 10, the convex portion 423 is formed to be convex so as to be away from the electrode assembly 10 at the outer side based on the diameter direction of the center portion 422, and the outer portion 424 forms the same plane as the central portion 422 toward the electrode assembly 10 at the outer side based on the diameter direction of the convex portion 423.

That is, an inner inclined surface 425 and an outer inclined surface 426 are formed at a portion where the central portion 422 and the convex portion 423 are connected and a portion where the convex portion 423 and the outer portion 424 are connected. The inner inclined surface 425 and the outer inclined surface 426 increase the rigidity of the vent plate 42 against the internal pressure of the rechargeable battery.

The notch 421 is formed on the inner surface of the convex portion 423 and the outer inclined surface 426 to receive intense or extreme internal pressure during an event so that it may be easily cut or broken. The notch 421 may be formed in the entire area along the circumferential direction of the vent plate 42, or may be formed in a plurality of areas spaced apart at predetermined intervals.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

Description of symbols

| | |
|---|---|
| 10: electrode assembly | 11: first electrode |
| 11a, 12a: coating portion | 11b, 12b: uncoated portion |
| 12: second electrode | 13: separator |
| 20: case | 21: first opening |
| 22: second opening | 23: beading portion |
| 24: crimping portion | 31: first current collecting plate |
| 32: second current collecting plate | 41: electrode terminal |
| 42: vent plate | 50: gasket |
| 51: escape groove | 52: compression portion |
| 53, 323: through-hole | 54: upper surface |
| 55: lower surface | 56: convex portion |
| 211: sealing member | 232: flat portion |
| 271: first elastic bending portion | 322: wing welding portion |
| 272: second elastic bending portion | 325: second welding line |
| 321: bottom welding portion | 327: elastic portion |
| 324: first welding line | 421: notch |
| 326: base portion | 423: convex portion |
| 328: concave groove | 425: inner inclined surface |
| 422: central portion | H1, H2: upward height |
| 424: outer portion | W: width of elastic portion |
| 426: outer inclined surface | |
| L: length | |
| θ: inclination angle | |

What is claimed is:

1. A rechargeable battery comprising:
an electrode assembly comprising a first electrode, a separator, and a second electrode in a jelly roll configuration;
a case accommodating the electrode assembly;
an electrode terminal in an insulating state at a first opening on one side of the case;
a first current collecting plate connecting the first electrode to the electrode terminal;
a vent plate sealing a second opening on an other side of the case;
a second current collecting plate connecting the second electrode to a beading portion of the case at an inner side of the vent plate; and
a gasket between the second collecting plate and the vent plate and between the second collecting plate and the case, the gasket forming a seal between a crimping portion and the beading portion of the case,
wherein the second current collecting plate comprises:
a base portion on an uncoated portion of the second electrode,
a bottom welding portion extending in a radial direction from the base portion and welded to the uncoated portion of the second electrode, and
a wing welding portion spaced apart from the bottom welding portion and connected to the base portion by an elastic portion and welded to the beading portion of the case.

2. The rechargeable battery as claimed in claim 1, wherein
a plurality of the bottom welding portions and a plurality of the wing welding portions are alternately arranged in a circumferential direction of the base portion.

3. The rechargeable battery as claimed in claim 2, further comprising
a through-hole in a center of the base portion, and wherein
the bottom welding portion and the elastic portion are connected by a concave groove at the base portion.

4. The rechargeable battery as claimed in claim 3, wherein:
the bottom welding portion is coupled to the second electrode by a first welding line extending along a radial direction of the second current collecting plate, and
the wing welding portion is coupled to the beading portion of the case by a second welding line extending along a circumferential direction of the second current collecting plate.

5. The rechargeable battery as claimed in claim 4, wherein
the wing welding portion extends in the circumferential direction and is longer than a width of the elastic portion.

6. The rechargeable battery as claimed in claim 1, wherein
the elastic portion comprises:
a first elastic bending portion connected to the base portion, the first elastic bending portion being bent upwardly and is bent outwardly in a radial direction, and
a second elastic bending portion connected to the first elastic bending portion and the wing welding portion, the second elastic bending portion being bent upwardly and bent outwardly at an incline in the radial direction.

7. The rechargeable battery as claimed in claim 6, wherein
the gasket comprises an escape groove accommodating the wing welding portion.

8. The rechargeable battery as claimed in claim 7, wherein:
the beading portion comprises a flat portion on an upper side of an inwardly convex curved portion, and
the wing welding portion is welded to the flat portion.

9. The rechargeable battery as claimed in claim 8, wherein
the escape groove comprises a right angle at a side of the wing welding portion and an obtuse angle corresponding to the second elastic bending portion at an inner side in the radial direction.

10. The rechargeable battery as claimed in claim 1, wherein
an inner surface of the vent plate comprises a notch.
